(19) United States
(12) Patent Application Publication
(10) Pub. No.: US 2002/0059873 A1
(43) Pub. Date: May 23, 2002

(54) Punching device for the punching of printing plates and printing plate recorder equipped with a punching device

(76) Inventors: Gunnar Behrens, Kiel (DE); Bernd Lassen, Monkeberg (DE)

Correspondence Address: LERNER AND GREENBERG, P.A., Post Office Box 2480, Hollywood, FL, 33022-2480, US

(21) Appl. No.: 10/062,059

(22) Filed: Feb. 1, 2002

(30) Foreign Application Priority Data
Feb. 1, 2001 (DE) 101 04 417.8

(51) Int. Cl. B31F 1/07; B44B 5/00

(52) U.S. Cl. 101/3.1

(57) ABSTRACT

A punching device punches, in particular register punches, printing plates, in particular for placement in the region of a printing plate recorder, preferably in the edge region of a trough of an inner-drum plate recorder. The punching device includes a punching plunger that is guided so as to be movable and drivable transversely to or more or less perpendicularly to a positioning surface for the printing plate to be punched and that is equipped with a punching tool for engaging over the edge of the printing plate to be punched. The punching device is a continuous punch, in which the punching tool can be drawn completely through the printing plate to be punched and can be lowered in or below the positioning surface (9) of the latter. A printing plate recorder is also provided.

### BACKGROUND OF THE INVENTION

### FIELD OF THE INVENTION

The invention relates to a punching device for the punching, in particular register punching, of printing plates, in particular for placement in the region of a printing plate recorder, preferably in the edge region of a trough of an inner-drum plate recorder. The recorder includes a punching plunger that is guided so as to be movable and drivable transversely to or more or less perpendicularly to a positioning surface for the printing plate to be punched and that is equipped with a punching tool for engaging over the edge of the printing plate to be punched.

In addition, the invention relates to a printing plate recorder, preferably an inner-drum printing plate recorder, that is equipped with at least one punching device of the abovementioned generic type.

A punching device of the abovementioned generic type is known from European Patent EP 0 759 851 B1, which corresponds to U.S. Pat. No. 5,896,815.

Punching devices of this type punch recesses in printing plates, in particular in offset printing plates. With the aid of which, the printing plates can be tension-mounted into the printing machine with an exact fit before printing. Preferably, the printing plates are tension-mounted onto a printing plate cylinder. An exact fit is required for harmonious multicolor printing. The punching recesses in the printing surface of the printing plate that has previously been exposed in the printing plate recorder allow the printing plate to be placed on the printing form cylinder. Such punching could also take place outside the printing plate recorder in a separate punching appliance. However, the punching should be conducted (and usually is conducted) in the printing plate recorder itself to achieve an exact dimension of the punched recesses in relation to the exposed surface. Punching devices of this type are therefore preferably disposed in printing plate recorders themselves; however, inner-drum, flatbed and outer-drum plate recorders also may include such punching devices. European Patent EP 0 759 851 B1 refers to an inner-drum plate recorder that also relates to the present invention.

In an inner-drum plate recorder, the printing plate to be exposed is introduced into the interior, via the trough, of an approximately semicylindrical drum. The printing plate is fixed in the exposure position usually by negative air pressure (i.e., a vacuum). Usually, laser light exposes the printing plate. The laser light may be low-energy, for example infrared. The low-energy laser-light exposed printing plate continues to be sensitive to light, like a film that must be developed and fixed. If laser light is of higher energy, for example ultraviolet, the printing plate will be thermally exposed and thus insensitive to daylight.

In both methods, the exposure device is located essentially near the cylinder axis of the inner drum. Moreover, for exposure, the printing plate must be brought into the trough and, after exposure, removed from the trough again. The interior of the exposure drum likewise must be used. Not much space therefore remains for placing the punching device or the punching devices. The known punching device is disposed at that edge of the trough that is located opposite the entry and exit side for the printing plate.

Because printing plates with different formats are to be exposed in the same trough, after exposure, a relatively smaller printing plate first must be displaced out of the exposed position, opposite to its exit direction, to the punching device and brought into abutment against the punching plunger for punching before it can be extracted from the trough in the exit direction. This makes the handling of the printing plate more difficult, more time-consuming, and more inaccurate.

In addition, different punchings must be conducted for printing machines from different manufacturers. In particular the recesses, which are generally U-shaped or tongue shaped, must project or lead into the printing plate surface to a different depth. This means that, if the same punching tool is used, the edge of the respective printing plate must be positioned differently in relation to the punching tool, if an exchange of the punching tool is to be avoided. This, too, makes the handling of a printing plate in the plate recorder difficult and time-consuming.

For less-common printing machines, the punching device provided in the plate recorder may not be able to punch. In such cases, the punching must be conducted in a separate external punching appliance, if appropriate on the premises of the printing machine operator. Nevertheless, for this purpose, at least a dimensional positioning of the exposed surface of the printing plate in relation to the edge of the printing plate should already be completed in the plate recorder itself in order to prepare for and ensure exact external punching without the handling of the printing plate in the plate recorder. This process is relatively difficult and time-consuming.

### SUMMARY OF THE INVENTION

It is accordingly an object of the invention to provide a punching device for the punching of printing plates and a printing plate recorder equipped with a punching device that overcome the hereinafore-mentioned disadvantages of the heretofore-known devices of this general type and that handle the printing plate in the plate recorder in a simple manner.

With the foregoing and other objects in view, there is provided, in accordance with the invention, a continuous to punching device for punching printing plates having an edge and a positioning surface. A punching plunger is guided to be movable and drivable transversely and perpendicularly to a positioning surface for the printing plate to be punched. The punching plunger has a punching tool for engaging the edge of the printing plate to be punched. The punching tool is drawn completely through the printing plate to be punched and is lowerable at least to the positioning surface of the printing plate.

With the objects of the invention in view, there is also provided a printing plate recorder. The printing plate recorder includes a continuous punching device as described above. The punching device is disposed within a path of the printing plate to be exposed.

This object is achieved, according to the invention, with a punching device configured as a continuous punch, in which the punching tool can be drawn completely through the printing plate to be punched and can be lowered in or below the positioning surface of the printing plate, which may also be a tangential surface to a trough. The phrase “below the positioning surface” is in this case not necessarily to be understood as being in the vertical direction, but in the sense of “on the printing plate rear side, facing away from the exposure side of the printing plate.”

Because, according to the invention, the punching tool can be lowered in the positioning surface of the printing plate, the printing plate also can be moved particularly advantageously over the region of the punching device, without the punching device causing any disturbance during this movement cycle. The handling of the printing plate in the plate recorder thereby becomes simpler. To be precise, the punching device may also be disposed in the path of movement of the printing plate, for example on the entry and exit side for the printing plate. A plate recorder also can be constructed according to the invention in this way.

For introduction into the plate recorder, the printing plate can be moved over and beyond the lowered punching device and first be exposed in the recorder position. For punching, the exposed printing plate is moved toward the punching device and brought into the operating position. This is particularly necessary in the case of a printing plate of relatively smaller format. A further advantage includes moving the exposed printing press in the direction in which the printing plate must be moved to be extracted from the plate recorder. After punching, the punching tool drawn through the printing plate is lowered again, so that the printing plate can then be extracted from the plate recorder, again over and beyond the punching device. Semiautomatic or fully automatic printing plate feed and discharge can thereby be controlled in a considerably simpler and more cost-effective way and be carried out more quickly, specifically with somewhat greater precision.

In a preferred embodiment, the punching plunger of the punching device includes a shank and a punching plunger head with a punching tool projecting from the shank. This not only allows the punching tool to engage over the edge of the printing plate for punching, but, according to preferred developments of the invention, the various portions of the punching plunger may also advantageously assume various positioning functions for the edge of the printing plate.

The extended shank of the punching plunger may serve as an abutment for the edge of the printing plate for punching the printing plate, so that the over-engaging depth of the punching tool over the edge of the printing plate is set accurately and reproducibly. If different abutment regions for the printing plates are provided over a different radial extent of the shank (which can bring different extension positions of the shank into action in the positioning plane of the printing plate) then different over-engaging depths of the punching tool can be set accurately and selected for different printing machines from different manufacturers.

Even when punching is not to be conducted in the plate recorder (for example, in connection with a less common printing machine) then, according to a further development of the invention, the only somewhat extended punching plunger head may serve as an abutment for the alignment of the printing plate. Such an extended punching plunger head can be used for the dimensional setting of the printing plate surface to be exposed in relation to the edge of the printing plate with a view to later punching.

The punching tool takes up the punching waste by moving it into its lowering depression. The lowering depression can be ejected in the lowering depression through a discharge shaft.

A plurality of punching devices can be disposed a distance from one another on a printing plate recorder for register punching.

Other features which are considered as characteristic for the invention are set forth in the appended claims.

Although the invention is illustrated and described herein as embodied in a punching device for the punching of printing plates and a printing plate recorder equipped with a punching device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a fragmentary, diagrammatic, sectional view showing a punching device with a printing plate running past it;

FIG. 2 is a fragmentary, diagrammatic, sectional view showing the punching device according to FIG. 1 with a printing plate in abutment;

FIG. 3 is a fragmentary, diagrammatic, sectional view showing the punching device according to FIGS. 1 and 2 after punching;

FIG. 4 is a fragmentary, diagrammatic, sectional view showing a printing plate in abutment against the shank of a punching plunger of a punching device according to FIGS. 1 to 3;

FIG. 5 is a fragmentary, diagrammatic, sectional view showing a printing plate in abutment against the punching plunger head of a punching plunger according to FIG. 4; and

FIG. 6 is a fragmentary, diagrammatic, sectional view showing a printing plate in abutment in a recess of the shank according to FIG. 4.

### DESCRIPTION OF THE PREFERRED EMBODIMENTS

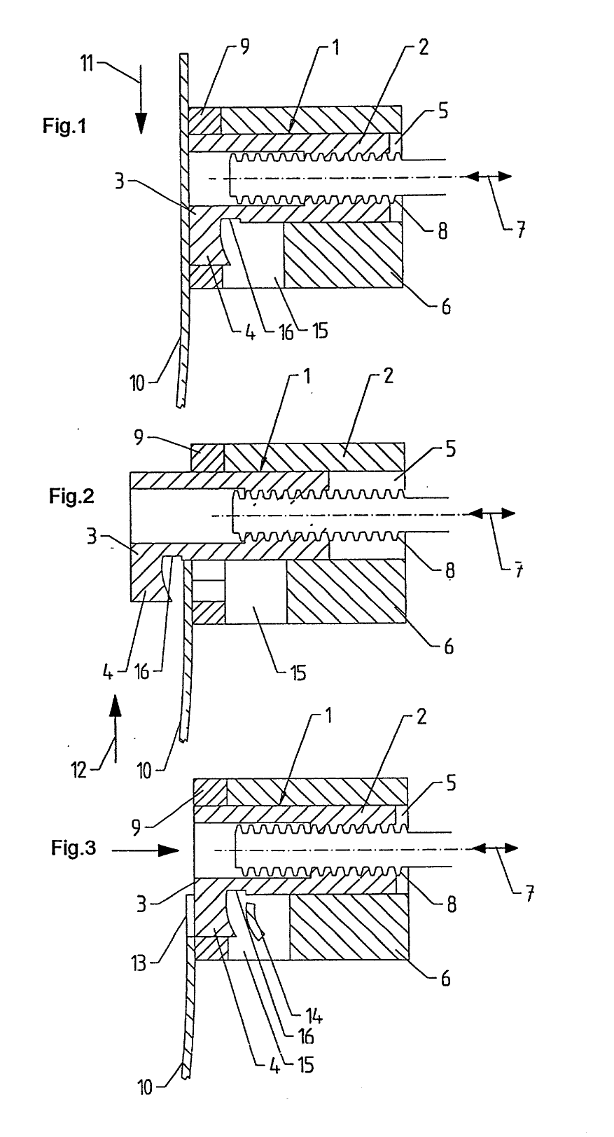

Referring now to the figures of the drawings in detail and first, particularly to FIG. 1 thereof, there is shown, in section, an exemplary embodiment of a punching device according to the invention. The punching device includes a punching plunger 1 with a shank 2 and a punching plunger head 3. The punching plunger head 3 has a punching tool 4: more precisely, a punching finger or a punching needle. The shank 2 is guided in a guide 5 of a punching head 6. The punching plunger head 3 can be lowered into the guide 5. The punching plunger 1 can be extended from the punching head 6 and retracted again in the direction of the double arrow 7. For this purpose, in the exemplary embodiment shown, a spindle 8 drives the punching plunger 1. Other drives also come under consideration.

A positioning surface 9 coincides in the region of the punching device with an end face of the punching head 6. A printing plate 10 is guided on the positioning surface 9, past the punching device or is guided with its lowered punching plunger over and beyond the punching device, specifically in the direction of the arrow 11, into a non-illustrated trough of an inner-drum printing plate recorder. The punching device is disposed at the edge of inner-drum printing plate recorder. FIG. 1 shows that the printing plate 10, which is illustrated in truncated form, follows the partially shown curvature of the trough.

FIG. 2 shows the punching device according to FIG. 1, likewise in section, with the punching plunger 1 in another position. The punching plunger 1 is extended from its lowering depression to such an extent such that the punching tool 4 is in the operating position for a punching operation. The printing plate 10 to be punched is already positioned correspondingly, in that it is in abutment against the shank 2 of the punching plunger 1. For this purpose, the printing plate 10 has previously been displaced in the direction of the arrow 12 against the shank 2 of the punching plunger 1.

FIG. 3 shows the punching device, again in section, after the punching operation, that is to say after the punching head 3 has been drawn through the printing plate 10, at the same time producing a recess 13, and has been lowered in a punching head 6 again. Punching waste 14 from the recess 13 is ejected from the punching head 6 through a discharge shaft 15.

Moreover, the shank 2 of the punching plunger 1 has a recess 16 that may function as an alternative abutment region for the printing plate 10, as will be explained in more detail in connection with the following figures.

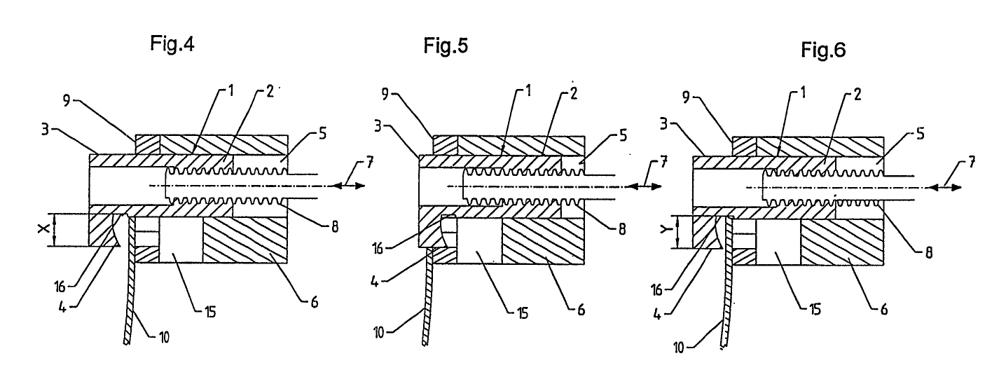

FIGS. 4 to 6 show, in section, the punching device according to the preceding figures, with the punching plunger 1 in various operating positions. The same structural elements are designated by the same reference numbers as in the preceding figures.

In FIG. 4, the punching tool 4 is in the punching position, and the punching plunger 1 is extended correspondingly far from the punching head 6. The printing plate 10 abuts the shank 2, specifically in the region with the larger diameter outside the recess 16. FIG. 4 therefore corresponds to FIG. 2.

This positioning of the printing plate for the dimensionally accurate punching-out of a recess 13 is correct for some printing machines. The abutment of the printing plate 10 against the shank 2 defines the over-engaging depth of the punching tool 4 over the edge of the printing plate 10 and therefore the depth of the recess 13.

In FIG. 6, the printing plate 10 abuts the recess 16 on the shank 2, for which purpose the punching plunger 1 is extended from the punching head 6 to a somewhat lesser extent than in FIG. 4. The engagement of the punching tool 4 over the edge of the printing plate 10 thereby becomes greater and the recess 13 deeper, this being correct for some other printing machines. The over-engaging depth of the punching tool over the edge of the printing plate may be designated in FIGS. 4 and 6 by X and Y respectively.

In FIG. 5, the punching plunger 1 is retracted even further into the punching head 6 than in FIG. 6. However, the punching plunger head 3 still projects or rises from the punching head 6. By projecting, the plunger head 3 may serve as an abutment for the printing plate 10, in order to find and fix a dimension for the distance of the surface to be exposed from the edge face of the printing plate 10, in the event that punching by the punching tool 4 is not to be carried out for a less common printing machine.

We claim:

1. A continuous punching device for punching a printing plate having an edge and a positioning surface, the punching device comprising:
a punching plunger being guided for moving and driving relative to the positioning surface of the printing plate to be punched;
said punching plunger having a punching tool for engaging the edge of the printing plate to be punched; and
said punching tool to be drawn completely through the printing plate to be punched and to be lowered at least to the positioning surface of the printing plate.

2. The punching device according to claim 1, wherein said punching plunger moves transversely to the positioning surface of the printing plate.

3. The punching device according to claim 1, wherein said punching plunger moves perpendicularly to the positioning surface of the printing plate.

4. The punching device according to claim 1, wherein said punching tool is to be lowered below the positioning surface of the printing place.

5. The punching device according to claim 1, wherein said punching plunger has a shank with a free end; and
a punching plunger head includes said punching tool and projects from said free end of said shank.

6. The punching device according to claim 5, wherein:
said punching plunger head abuts the printing plate to be positioned; and
said punching plunger of said punching plunger head rises above the positioning surface of the printing plate.

7. The punching device according to claim 6, wherein said punching tool does not assume any operating positions.

8. The punching device according to claim 5, wherein:
said shank abuts the printing plate to be positioned; and
said punching tool rises above the positioning surface of the printing plate.

9. The punching device according to claim 8, wherein:
said shank has two abutment positions for the printing plate to be positioned, said punching tool engages the edge of the printing plate differently in the abutment positions; and
said punching plunger has a plurality of positions correlating to the abutment positions of said shank.

10. The punching device according to claim 1, including a discharge shaft for receiving punching waste cut from the printing plate.

11. A printing plate recorder, comprising:
a continuous punching device for punching a printing plate having an edge and a positioning surface, said continuous punching device including:
a punching plunger being guided for moving and driving relative to the positioning surface for the printing plate to be punched;
said punching plunger having a punching tool for engaging the edge of the printing plate to be punched; and
said punching tool to be drawn completely through the printing plate to be punched and to be lowered at least to the positioning surface of the printing plate;
said punching device being disposed within a path of the printing plate to be exposed.

12. The printing plate recorder according to claim 11, including an entry side for the printing plate; said punching device being disposed on said entry side.

13. The printing plate recorder according to claim 12, including an exit side for the printing plate, said punching device being disposed on said exit side.

14. The printing plate recorder according to claim 11, including an exit side for the printing plate, said punching device being disposed on said exit side.

15. The printing plate recorder according to claim 11, including a plurality of said punching devices spaced transversely to a path of movement of the printing plate.
